(19) United States
(12) Patent Application Publication
(10) Pub. No.: US 2023/0115008 A1
(43) Pub. Date: Apr. 13, 2023

(54) MANAGEMENT UNIT FOR MANAGING MATERIAL DUMPING, SYSTEM, AUTONOMOUS DUMP MACHINE AND METHOD

(71) Applicant: Volvo Autonomous Solutions AB, Göteborg (SE)

(72) Inventors: Johan SJÖBERG, Västerås (SE); Calle SKILLSÄTER, Torshälla (SE)

(73) Assignee: Volvo Autonomous Solutions AB, Göteborg (SE)

(21) Appl. No.: 17/905,108

(22) PCT Filed: Feb. 28, 2020
(86) PCT No.: PCT/EP2020/055260

§ 371 Date: Aug. 26, 2022

(51) Int. Cl. G05D 1/02

(52) U.S. Cl. CPC G05D 1/0297; G05D 1/0214; G05D 2201/0202

(57) ABSTRACT

A management unit for managing material dumping in a dump area using a plurality of autonomous dump machines. Each autonomous dump machine comprises a sensor arrangement adapted to determine at least one sensor arrangement parameter indicative of the environment adjacent to at least a portion of the autonomous dump machine. The management unit is adapted to establish a set of dump paths, comprising at least one dump path, wherein each dump path extends in the dump area, and issue an instruction to an autonomous dump machine of the plurality of autonomous dump machines to follow a dump path of the set of dump paths until the sensor arrangement parameter, determined by the sensor arrangement of the autonomous dump machine, indicates that the autonomous dump machine has reached a dumping position indicative of a dumping density of the dump area being within a predetermined dumping density range.

### TECHNICAL FIELD

The present invention relates to a management unit for managing material dumping in a dump area. Furthermore, the present invention relates to a system for material dumping in a dump area. Moreover, the present invention relates to an autonomous dump machine. Further, the present invention relates to a method for dumping material in a dump area.

The invention is applicable on working machines within the fields of industrial construction machines or construction equipment, in particular haulers. Although the invention will be described with respect to an autonomous hauler, the invention is not restricted to this particular machine, but may also be in other working machines such as wheel loaders, excavators and backhoe loaders.

### BACKGROUND

A plurality of autonomous dump machines may be used for dumping material in a dump area. For instance, US 2018/0088591 A1 discloses a system for planning material dumping operations. The US 2018/0088591 A1 system is adapted to plan an array of dump locations. However, there is a risk that material dumped in the above-mentioned dump locations will result in that the dump area is not filled in a desired manner.

### SUMMARY

An object of the present invention is to provide a management unit that improves filling of a dump area.

The above object is achieved by the management unit according to claim 1.

As such, a first aspect of the present disclosure relates to a management unit for managing material dumping in a dump area using a plurality of autonomous dump machines. Each autonomous dump machine comprises a sensor arrangement adapted to determine at least one sensor arrangement parameter indicative of the environment adjacent to at least of portion of the autonomous dump machine. The management unit is adapted to:
establish a set of dump paths, comprising at least one dump path, wherein each dump path extends in the dump area,
issue an instruction to an autonomous dump machine of the plurality of autonomous dump machines to follow a dump path of the set of dump paths until the sensor arrangement parameter, determined by the sensor arrangement of the autonomous dump machine, indicates that the autonomous dump machine has reached a dumping position indicative of a dumping density of the dump area being within a predetermined dumping density range.

By virtue of the management unit, which issues instructions to one or more autonomous dump machines, it is possible to control the autonomous dump machine so as to determine a suitable dumping position on the basis of the sensor arrangement parameter, rather than on a predetermined position alone. The autonomous dump machine may thereafter dump the material at the dumping position. Purely by way of example, the autonomous dump machine itself may take the decision to dump the material at the determined dumping position. As such, the management unit in accordance with the first aspect of the present invention implies that a dump area may be appropriately filled, such as more densely filled. Purely by way of example, the management unit may assure the dumping density of the dump area is within a predetermined dumping density range when the dumping operation has been completed. Once the autonomous dump machine has reached the dumping position, the autonomous dump machine may dump the carried material at the dumping position.

The management unit may comprise a data processing device and a memory having a computer program stored thereon, the computer program comprising program code which, when executed by the data processing device, causes the data processing device to issue the instruction, or command issuance of the instruction, to the autonomous dump machine. The computer program may further comprise program code which, when executed by the data processing device, causes the data processing device to perform, and/or command performance of, various steps as described herein. Furthermore, the management unit may be adapted to communicate with the plurality of autonomous dump machines, for instance using wireless communication means. The management unit may be adapted to be located at a work site, e.g. close to the dump area. Alternatively, the management unit may be adapted to be located remotely from the work site.

As used herein, the expression “dumping density” relates to the mass of the dumped material over a certain area. As such, the “dumping density” may be defined in terms of the unit mass/area—such as for instance kg/m²—and the above-mentioned predetermined dumping density range may be expressed as a range of x-y mass/area, such as X-Y kg/m², of dumped material.

Purely by way of example, the management unit according to the first aspect of the present invention, which issues the above-mentioned instruction, implies that a dump area for instance may be filled with inhomogeneous material whilst nevertheless enabling an appropriate filling of the dump area. Moreover, the management unit according to the first aspect of the present invention implies that an appropriate filling of the dump area may be obtained even if the autonomous dump machines are filled to different levels during the dumping procedure and/or if different types of autonomous dump machines are using in a dumping procedure.

Purely by way of example, the dump area may be defined by geographical boundaries and the system may be adapted to establish boundary information relating to the geographical boundaries of the dump area.

Optionally, the management unit is adapted to receive dump information from the autonomous dump machine relating to where the autonomous dump machine has dumped its load. Preferably the management unit is also adapted to receive shape information indicative of the shape of the load dumped by the autonomous dump machine. The management unit is further adapted to generate a dump map indicative of material currently dumped in the dump area on the basis of the received dump information, and optionally also on the basis of the shape information.

The information relating to the load dumped by the autonomous dump machine, such as the above-mentioned dump map, may be useful information when determining how to proceed with the dumping in the dump area.

Optionally, the management unit is adapted to determine a set of dump paths comprising at least one dump path on the basis of at least the dump map. As such, the management unit may be adapted to determine one or more dump paths in the dump area in an adaptive manner, taking information from the dump map into account. Such an adaptive path determination implies that dump area paths may be chosen in an appropriate manner.

Optionally, the management unit is adapted to determine a transversal dump path deviation threshold for a dump path. The transversal dump path deviation threshold is indicative of how much an autonomous dump machine is allowed to transversally deviate from the dump path in a direction towards an adjacent dump path. The management unit is adapted to determine the transversal dump path deviation threshold on the basis of the dump map.

Optionally, the management unit is adapted to set a first transversal dump path deviation threshold for a dump path based on a determination that the adjacent dump path is at least partially filled with material. Moreover, the management unit is adapted to set a second transversal dump path deviation threshold for a dump path based on a determination that the adjacent dump path is not filled with material. The first transversal dump path deviation threshold is greater than the second transversal dump path deviation threshold.

As such, the management unit may allow an autonomous dump machine to move closer to an adjacent dump path, assuming that the adjacent dump path is at least partially filled with material. This in turn implies that the autonomous dump machine may dump its load at a transversal location that is closer to the adjacent and at least partially filled dump path, as compared to a scenario in which the adjacent path is empty, which in turn implies an increased possibility to obtain a dumping density, also as seen in a transversal direction of a dumping path, within the predetermined dumping density range.

Optionally, the management unit is adapted to split the dump area into a plurality of adjacent dump paths, each dump path being associated with a dump path width profile such that the plurality of dump paths covers the dump area. This implies a possibility to plan the dumping in the dump area in an appropriate manner.

A second aspect of the present invention relates to a system for material dumping in a dump area, the system comprising the management unit according to the first aspect of the present invention and a plurality of autonomous dump machines. Each autonomous dump machine comprises a sensor arrangement adapted to determine at least one sensor arrangement parameter indicative of the environment adjacent to at least a portion of the autonomous dump machine.

Optionally, the sensor arrangement parameter is indicative of a dump material height of dump material located in front of the autonomous dump machine, as seen along the dump path. The autonomous dump machine is adapted to determine that the autonomous dump machine has reached the dumping position in response to determining that the dump material height equals or exceeds a predetermined dump material height threshold value. The dump material height may be a useful parameter when determining where to dump a subsequent load.

Optionally, the dump path is associated with a dump path width profile. The autonomous dump machine is adapted to use sensor information from the sensor arrangement being related to, preferably limited to, information within the dump path width profile. Using sensor information related to information within the dump path width profile implies reduced risk in determining an appropriate dumping position on less relevant observations made by the sensor arrangement. Purely by way of example, using sensor information from the sensor arrangement being related to, preferably limited to, information within the dump path width profile implies a reduced risk for the autonomous dump machine to use sensor information relating to adjacent dump paths when determining an appropriate dumping position.

Optionally, the sensor arrangement is adapted to determine an inclination of the autonomous dump machine.

Optionally, the sensor arrangement is adapted to detect a pitch of the autonomous dump machine. The autonomous dump machine may in this case be adapted to determine that the autonomous dump machine has reached the dumping position in response to determining that the detected pitch equals or exceeds a predetermined pitch inclination threshold angle. A detected pitch that equals or exceeds a predetermined pitch inclination threshold angle may be indicative of the autonomous dump machine ascending a previously dumped pile of material. As such, the detected pitch may be useful information when determining the dumping position.

Optionally, the sensor arrangement is adapted to detect a roll of the autonomous dump machine. The autonomous dump machine is adapted to determine that the autonomous dump machine should discontinue following the dump path in response to determining that the detected roll equals or exceeds a predetermined roll inclination threshold angle. A detected roll that equals or exceeds a predetermined roll inclination threshold angle may imply that the ground on which the autonomous dump machine is travelling is too soft for the autonomous dump machine. As such, using the detected roll implies a reduced risk of the autonomous dump machine being stuck in a dump path.

Optionally, each autonomous dump machine of the plurality of autonomous dump machines is adapted to dump material carried by the autonomous dump machine at the dumping position, e.g. upon reaching the dumping position.

A third aspect of the present invention relates to an autonomous dump machine comprising a sensor arrangement adapted to determine at least one sensor arrangement parameter indicative of the environment adjacent to at least a portion of the autonomous dump machine. The autonomous dump machine is adapted to receive information relating to a dump path forming part of a dump area intended to be filled with dump material. The autonomous dump machine is adapted to follow the dump path until the sensor arrangement parameter, determined by the sensor arrangement of the autonomous dump machine, indicates that the autonomous dump machine has reached a dumping position indicative of a dumping density of the dump area being within a predetermined dumping density range. The autonomous dump machine is further adapted to dump material carried by the autonomous dump machine at the dumping position.

Optionally, the sensor arrangement parameter is indicative of a dump material height of dump material located in front of the autonomous dump machine. The autonomous dump machine is adapted to determine that the autonomous dump machine has reached the dumping position in response to determining that the dump material height equals or exceeds a predetermined dump material height threshold value.

Optionally, the autonomous dump machine is adapted to receive information relating to a dump path width profile associated with the dump path. The autonomous dump machine is adapted to use sensor information from the sensor arrangement being related to, preferably limited to, information within the dump path width profile.

Optionally, the sensor arrangement is adapted to determine an inclination of the autonomous dump machine.

Optionally, the sensor arrangement is adapted to detect a pitch of the autonomous dump machine and the autonomous dump machine is adapted to determine that the autonomous dump machine has reached the dumping position in response to determining that the detected pitch equals or exceeds a predetermined pitch inclination threshold angle.

Optionally, the sensor arrangement is adapted to detect a roll of the autonomous dump machine and the autonomous dump machine is adapted to determine that the autonomous dump machine should discontinue following the dump path in response to determining that the detected roll equals or exceeds a predetermined roll inclination threshold angle.

Optionally, the sensor arrangement comprises a LIDAR sensor and/or a RADAR sensor. As another option, the sensor arrangement may comprise a camera.

Optionally, the autonomous dump machine is adapted to detect, preferably using the sensor arrangement, whether or not a portion of the dump area located adjacent to the dump path, as seen in a transversal direction perpendicular to a path extension along the dump path, is filled with material.

Optionally, the autonomous dump machine is adapted to, in response to detecting that the portion of the dump area located adjacent to the dump path is filled with material, use the sensor arrangement for determining a dumping position in the transversal direction indicative of a dumping density of the dump area being within a predetermined dumping density range.

A fourth aspect of the present invention relates to a method for dumping material in a dump area using a system comprising a management unit and a plurality of autonomous dump machines. Each autonomous dump machine comprises a sensor arrangement adapted to determine at least one sensor arrangement parameter indicative of the environment adjacent to at least a portion of the autonomous dump machine. The method comprises using the management unit for:
establishing a set of dump paths, comprising at least one dump path, wherein each dump path extends in the dump area, and
issuing an instruction to an autonomous dump machine of the plurality of autonomous dump machines to follow one of the dump paths until the sensor arrangement parameter, determined by the sensor arrangement, indicates that the autonomous dump machine has reached a dumping position indicative of a dumping density of the dump area being within a predetermined dumping density range, whereby the autonomous dump machine thereafter dumps material carried by the autonomous dump machine at the dumping position.

Optionally, the method further comprises receiving dump information from the autonomous dump machine relating to where the autonomous dump machine has dumped its load, preferably the method further comprises receiving from the autonomous dump machine shape information indicative of the shape of the load dumped by the autonomous dump machine. The method further comprises generating a dump map, using the management unit, indicative of material currently dumped in the dump area on the basis of the received information.

Optionally, the method further comprises determining a set of dump paths comprising at least one dump path on the basis of at least the dump map.

Optionally, the method further comprises comprising determining a transversal dump path deviation threshold for a dump path, the transversal dump path deviation threshold being indicative of how much an autonomous dump machine is allowed to transversally deviate from the dump path in a direction towards an adjacent path. The method comprises determining the transversal dump path deviation threshold on the basis of the dump map.

Optionally, the method further comprises setting a first transversal dump path deviation threshold for a dump path based on a determination that an adjacent dump path is at least partially filled with material, and setting a second transversal dump path deviation threshold for a dump path based on a determination that an adjacent dump path is not filled with material. The first transversal dump path deviation threshold is greater than the second transversal dump path deviation threshold.

Optionally, the method further comprises splitting the dump area into a plurality of adjacent dump paths, each dump path being associated with a path width profile such that the plurality of dump paths covers the dump area.

Optionally, each autonomous dump machine comprises a sensor arrangement adapted to determine at least one sensor arrangement parameter indicative of the environment adjacent to at least a portion of the autonomous dump machine.

Optionally, the sensor arrangement parameter is indicative of a dump material height of dump material located in front of the autonomous dump machine, the method comprising determining that the autonomous dump machine has reached the dumping position in response to determining that the dump material height equals or exceeds a predetermined dump material height threshold value.

Optionally, the dump path is associated with a dump path width profile, the method comprising using sensor information related to, preferably limited to, information within the dump path width profile.

Optionally, the sensor assembly is adapted to determine an inclination of the autonomous dump machine.

Optionally, the sensor arrangement is adapted to detect a pitch of the autonomous dump machine. The method comprises determining that the autonomous dump machine has reached the dumping position in response to determining that the detected pitch equals or exceeds a predetermined pitch inclination threshold angle.

Optionally, the sensor arrangement is adapted to detect a roll of the autonomous dump machine. The method comprises determining that the autonomous dump machine should not continue following the dump path in response to determining that the detected roll equals or exceeds a predetermined roll inclination threshold angle.

### BRIEF DESCRIPTION OF THE DRAWINGS

With reference to the appended drawings, below follows a more detailed description of embodiments of the invention cited as examples.

In the drawings:

FIG. 1 illustrates an embodiment of an autonomous dump machine,

FIG. 2 is a schematic top view of a an autonomous dump machine and a dump path,

FIG. 3 is a schematic side view of a an autonomous dump machine and a dump path,

FIG. 4 is a schematic side view of a an autonomous dump machine and a dump path,

FIG. 5 is a schematic top view of a an autonomous dump machine and a dump path,

FIG. 6 is a schematic top view of a system for material dumping,

FIG. 7 is a schematic illustration of a dump map, and

FIG. 8 is a schematic top view of a dump area.

### DETAILED DESCRIPTION

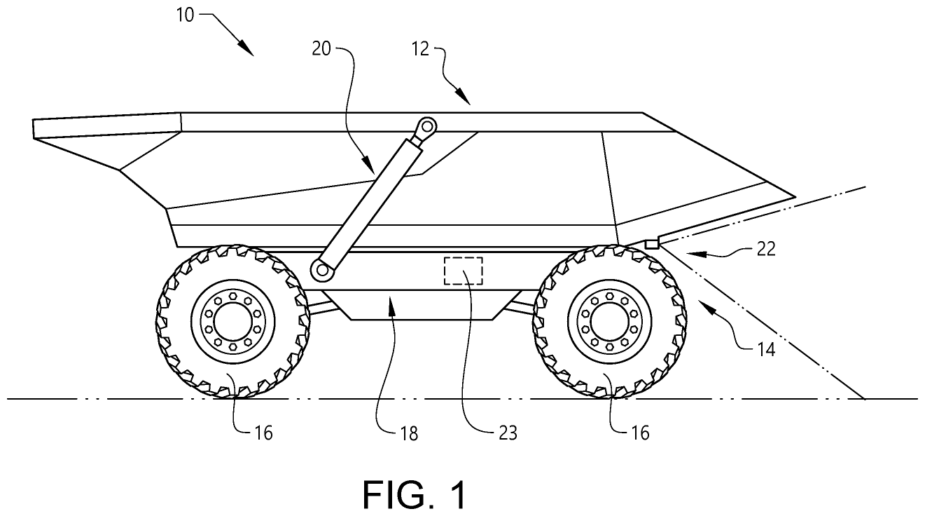

FIG. 1 illustrates an embodiment of an autonomous dump machine 10. The FIG. 1 autonomous dump machine 10 comprises a receptacle portion 12 for accommodating load. Purely by way of example, and as is indicated in FIG. 1, the receptacle portion 12 may be a loading platform of the autonomous dump machine 10.

The autonomous dump machine 10 further comprises a propulsion system 14 which in turn comprises one or more ground engaging members 16. In the FIG. 1 embodiment, the ground engaging members 16 are exemplified as wheels although other types of ground engaging members, such as crawlers (not shown) are also envisaged.

Furthermore, as indicated in FIG. 1, the autonomous dump machine 10 may comprise a machine frame 18 and a tipping system 20 for pivoting the receptacle portion 12 relative to the machine frame 18 to thereby allow material loaded in the receptacle portion 12 to be dumped. In the FIG. 1 embodiment, the tipping system 20 comprises a hydraulic actuator, more precisely a hydraulic cylinder, but it is also envisaged that that the tipping system 20 may comprise other components instead of, or in addition to, the hydraulic actuator. For instance, implementations of the tipping system 20 may comprise an electric motor (not shown).

Furthermore, as indicated in FIG. 1, the autonomous dump machine 10 comprises a sensor arrangement 22 adapted to determine at least one sensor arrangement parameter indicative of the environment adjacent to at least a portion of the autonomous dump machine 10. Purely by way of example, the sensor arrangement 22 may comprise a LIDAR sensor and/or a RADAR sensor. However, as will be discussed hereinbelow, the sensor arrangement 22 may comprise other types of sensors. Furthermore, the FIG. 1 embodiment of the autonomous dump machine 10 comprises a control unit 23, preferably an electronic control unit, for controlling the autonomous dump machine 10. Purely by way of example, the control unit 23 may be adapted to receive signals from the sensor arrangement 22 and from external entities, such as a management unit as will be discussed hereinbelow. As a non-limiting example, the control unit 23 may also be adapted to send signals. Where it is stated in the below description that the autonomous dump machine 10 is adapted to carry out certain operations, it should be understood that the autonomous dump machine 10 could carry out such operations using its control unit 23 for example.

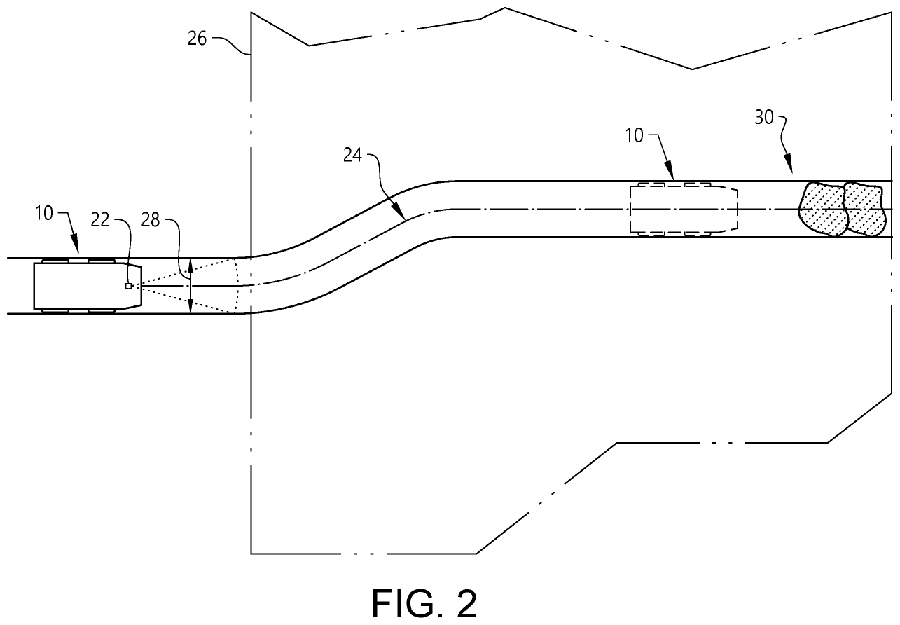

With reference to FIG. 2, the autonomous dump machine is adapted to receive information relating to a dump path 24 forming part of a dump area 26 intended to be filled with dump material. As is indicated in FIG. 2, each one of the dump area 26 and the dump path 24 may have any shape. In other words, the dump path 24 need not be a straight line and the dump area 26 need not be expressed as a basic shape, such as a rectangle or the like.

Purely by way of example, and as indicated in FIG. 2, the autonomous dump machine 10 may be adapted to receive information relating to a dump path width profile 28 associated with the dump path 24. In the FIG. 2 example, the dump path width profile 28 relates to a single width along the dump path 24. However, it is also envisaged that the dump path width profile 28 may be such that the width can vary along the dump path 24. As such, the dump path 24 may comprise information indicative of a centre line along which the autonomous dump machine 10 should travel. As a non-limiting example, the dump path width profile 28 may be selected so as to be associated with, preferably so as to substantially correspond to, the width of the autonomous dump machine 10.

Moreover, again purely by way of example, the autonomous dump machine 10 may be adapted to use sensor information from the sensor arrangement 22 being related to, preferably limited to, information within the dump path width profile 28. As such, with reference to FIG. 2, the autonomous dump machine 10 may be adapted to only use sensor information that is related to objects that are located within the dump path width profile 28. As a non-limiting example, such a relation or limitation may be achieved by altering the field-of-view of the sensor arrangement 22 in dependence on a determined dump path width profile 28. As another non-limiting example, the autonomous dump machine 10 may be adapted to receive sensor information from the sensor arrangement 22, including sensor information relating to areas outside the dump path width profile 28, but the autonomous dump machine 10 may be adapted to discard sensor information deemed to be related to areas outside the dump path width profile 28.

Furthermore, the autonomous dump machine 10 is adapted to follow the dump path 24 until the sensor arrangement parameter, determined by the sensor arrangement 22 of the autonomous dump machine, indicates that the autonomous dump machine 10 has reached a dumping position indicative of a dumping density of the dump area being within a predetermined dumping density range.

An example of such a dumping position is indicated by the dashed line in FIG. 2 indicating a future position of the autonomous dump machine 10. In the FIG. 2 example, the dumping position was determined in response to the sensor arrangement 22 detecting an entity 30, such as pile, of previously dumped material along the dump path 24.

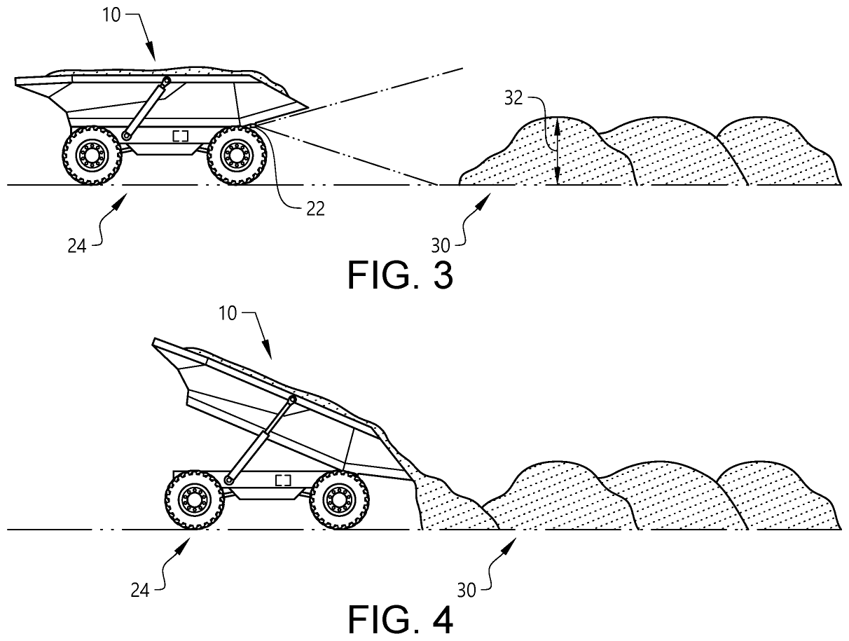

To this end, with reference to FIG. 3, although by way of example only, the sensor arrangement parameter may be indicative of a dump material height 32 of dump material 30 located in front of the autonomous dump machine 10. As such, the autonomous dump machine 10 may be adapted to determine that the autonomous dump machine 10 has reached the dumping position in response to determining that the dump material height 32 equals or exceeds a predetermined dump material height threshold value. To this end, the sensor arrangement 22 may comprises a sensor component, such as a GPS system, for determining the position of the autonomous dump machine 10.

As another non-limiting example, the sensor arrangement parameter may be indicative of the autonomous dump machine 10 reaching the end of the dump path 24. Thus, when an autonomous dump machine 10 follows a dump path 24 that has not yet been filled with material (since the sensor arrangement has not discovered any dumped material along the dump path 24), the autonomous dump machine 10 may be adapted to proceed as long as possible along the dump path 24 and thereafter dump the material at the end thereof.

As yet another non-limiting example, the sensor arrangement parameter may be indicative of an edge in the dump path 24. For example, the sensor arrangement parameter may be indicative of an edge associated with a downwardly extending slope after the edge and in response thereto determining that the autonomous dump machine 10 has reached a dumping position indicative of a dumping density of the dump area being within a predetermined dumping density range.

Furthermore, the sensor arrangement 22 may be adapted to determine an inclination of the autonomous dump machine 10.

As a non-limiting example, the sensor arrangement 22 may be adapted to detect a pitch of the autonomous dump machine 10. As used herein, the term “pitch” relates to an inclination angle of the autonomous dump machine 10 around an axis extending parallelly to a transversal axis of the autonomous dump machine 10.

Moreover, the autonomous dump machine 10 may be adapted to determine that the autonomous dump machine has reached the dumping position in response to determining that the detected pitch equals or exceeds a predetermined pitch inclination threshold angle. As such, again with reference to FIG. 2, when the autonomous dump machine 10 reaches a previously dumped entity 30, such as pile, the autonomous dump machine 10 will begin to ascend such an entity 30 resulting in an increased pitch of the autonomous dump machine 10. When the detected pitch equals or exceeds a predetermined pitch inclination threshold angle, it can be determined that the autonomous dump machine 10 has ascended the dumped material entity 30 to such an extent that dumping material from the autonomous dump machine 10 in such a position would result in an appropriate material filling.

As another non-limiting example, the sensor arrangement 22 may be adapted to detect a roll of the autonomous dump machine 10. As used herein, the term “roll” relates to an inclination angle of the autonomous dump machine 10 around an axis extending parallelly to a longitudinal axis L of the autonomous dump machine 10. The autonomous dump machine 10 may be adapted to determine that the autonomous dump machine 10 should discontinue following the dump path 24 in response to determining that the detected roll equals or exceeds a predetermined roll inclination threshold angle.

A detected roll that equals or exceeds a predetermined roll inclination threshold angle can imply that the autonomous dump machine 10 travels on a ground that is too soft for the autonomous dump machine 10. As such, the autonomous dump machine 10 may decide not to continue on the dump path 24 in response to determining that the detected roll equals or exceeds the predetermined roll inclination threshold angle.

Irrespective of how it is determined that the autonomous dump machine 10 has reached a dumping position indicative of a dumping density of the dump area 26 being within a predetermined dumping density range, the autonomous dump machine 10 is further adapted to dump material carried by the autonomous dump machine 10 at the dumping position. This is schematically illustrated in FIG. 4.

Moreover, the autonomous dump machine 10 may be adapted to detect, preferably using the sensor arrangement 22, whether or not a portion of the dump area 26 located adjacent to the dump path 24, as seen in a transversal direction T perpendicular to a path extension along the dump path, is filled with material.

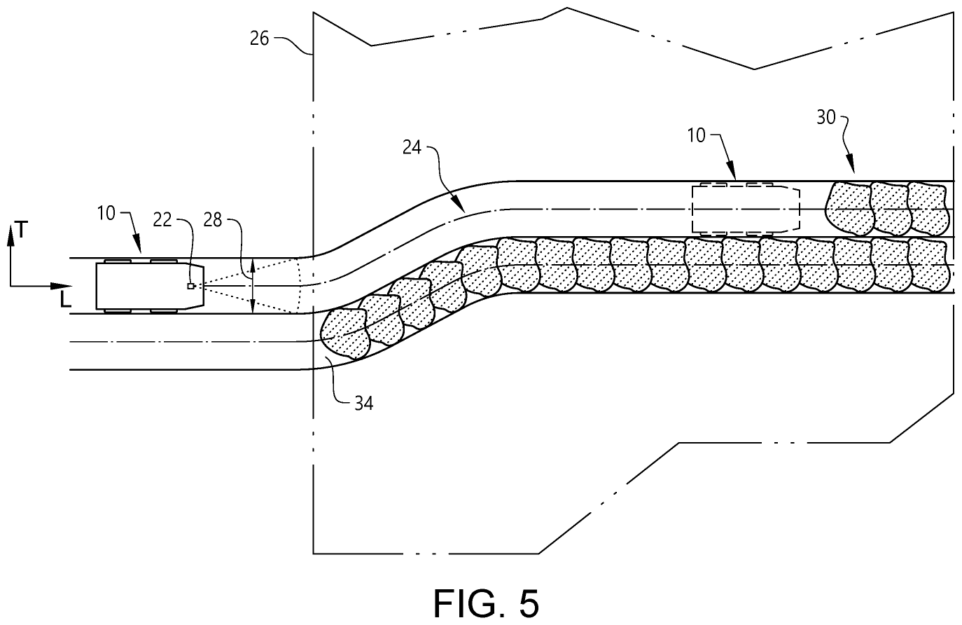

To this end, reference is made to FIG. 5 illustrating a scenario in which a previous dump path 34 has been filled with material and wherein the autonomous dump machine 10 is adapted to follow a current dump path 24. The autonomous dump machine 10 may be adapted to, in response to detecting that the portion of the dump area located adjacent to the dump path 24 is filled with material, use the sensor arrangement 22 for determining a dumping position in the transversal direction T indicative of a dumping density of the dump area being within a predetermined dumping density range.

Put differently, the autonomous dump machine 10 may be adapted to, in response to detecting that the portion of the dump area located adjacent to the dump path 24 is filled with material, move towards the previous dump path 34 in order to arrive at a dumping position in the transversal direction T indicative of a dumping density of the dump area being within a predetermined dumping density range.

As such, the autonomous dump machine 10 may be such that it departs from the current dump path 24, as seen in the transversal direction T, and approaches a transversally adjacent and already filled portion of the dump area 26 before dumping its material.

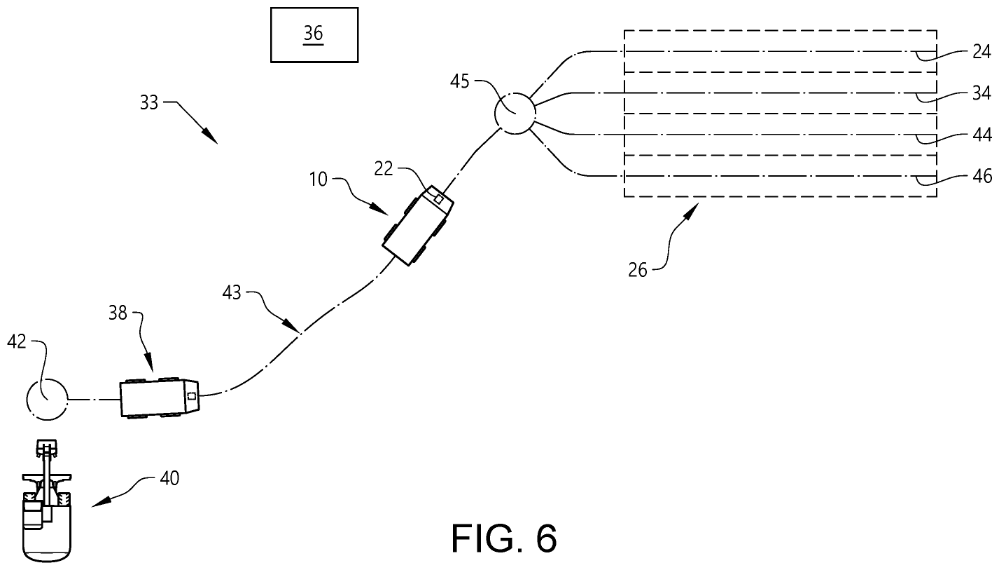

FIG. 6 illustrates a system 33 comprising a management unit 36 for managing material dumping in a dump area 26 using a plurality of autonomous dump machines 10, 38. Purely by way of example, and as indicated in FIG. 6, the dump area 26 may be defined by geographical boundaries and the system 33 may be adapted to establish boundary information relating to the geographical boundaries of the dump area 26.

Each one of the autonomous dump machines 10, 38 may be in accordance with any one of the above discussed embodiments of the autonomous dump machine 10.

Moreover, FIG. 6 further illustrates a working machine 40—which in FIG. 6 is implemented as an excavator—which is adapted to fill each one of the autonomous dump machines 10, 38 with material at a loading zone 42.

FIG. 6 further illustrates that the autonomous dump machines 10, 38 may be adapted to follow a common path 43 towards an intersection 45 located adjacent to the dump area 26. After the intersection 45, the autonomous dump machines 10, 38 travel towards a dump path 24, 34, 44, 46 in the dump area 26 as will be discussed hereinbelow.

The management unit 36 may be adapted to communicate with each one of the autonomous dump machines 10, 38. Purely by way of example, the management unit 36 may be adapted to wirelessly communicate with each one of the autonomous dump machines 10, 38. Furthermore, as another non-limiting example, the management unit 36 may be adapted to receive information, also for instance by means of wireless communication means, from each one of the autonomous dump machines 10, 38.

The management unit 36 is adapted to establish a set of dump paths 24, 34, 44, 46, wherein each dump path extends in the dump area 26. In the FIG. 6 embodiment, each one of the dump paths 24, 34, 44, 46 is a straight path and the dump area 26 is rectangular. However, in other embodiments, the dump area 26 may have an irregular shape and/or the dump paths 24, 34, 44, 46 need not necessarily be straight.

Furthermore, the management unit 36 is adapted to issue an instruction to an autonomous dump machine 10 of the plurality of autonomous dump machines 10, 38 to follow a dump path 24 of the set of dump paths 24, 34, 44, 46 until the sensor arrangement parameter, determined by the sensor arrangement 22 of the autonomous dump machine 10, indicates that the autonomous dump machine 10 has reached a dumping position indicative of a dumping density of the dump area being within a predetermined dumping density range. The autonomous dump machine 10 thereafter dumps material carried by the autonomous dump machine 10 at the dumping position.

In this example, the autonomous dump machine 10 sends dump information to the management unit 36 relating to where the autonomous dump machine has dumped its load. As such, though purely by way of example, when the autonomous dump machine 10 is dumping material or just has dumped material, it may issue a signal indicative of its position to the management unit 36.

Preferably the management unit 36 is also adapted to receive shape information indicative of the shape of the load dumped by the autonomous dump machine 10. To this end, the previously discussed sensor arrangement 22 may be used for determining the shape of the load just dumped by the autonomous dump machine 10 and such information may be sent from the autonomous dump machine 10 to the management unit 36.

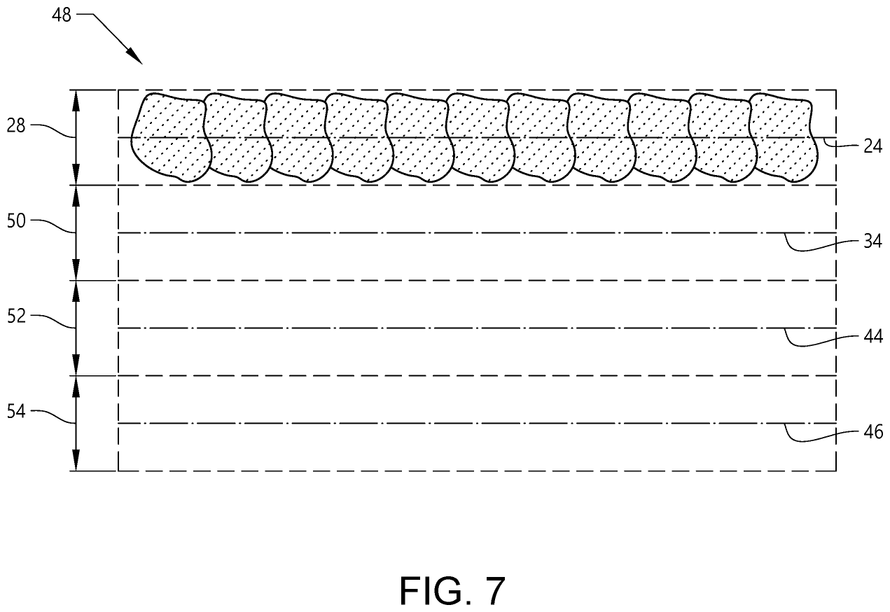

The management unit 36 may further be adapted to generate a dump map 48 indicative of material currently dumped in the dump area on the basis of the received information. FIG. 7 illustrates an implementation of a dump map 48.

The FIG. 7 implementation of the dump map 48 indicates that a first dump path 24 has been filled with material. Purely by way of example, the management unit 36 may be adapted to determine a set of dump paths comprising at least one dump path on the basis at least the dump map 48. Moreover, though purely by way of example, the management unit 36 may be adapted to determine a set of dump paths comprising at least one dump path on the basis of at least the dump map 48 as well as on the basis of the boundary information relating to the geographical boundaries of the dump area 26 as have been mentioned hereinabove.

As such, on the basis of the dump map, the management unit 36 may be adapted to determine additional dump paths. Thus, the management unit 36 may be adapted to operate in an adaptive manner and generate and/or update the set of dump paths 24, 34, 44, 46 on the basis of information obtained from a recent dump map.

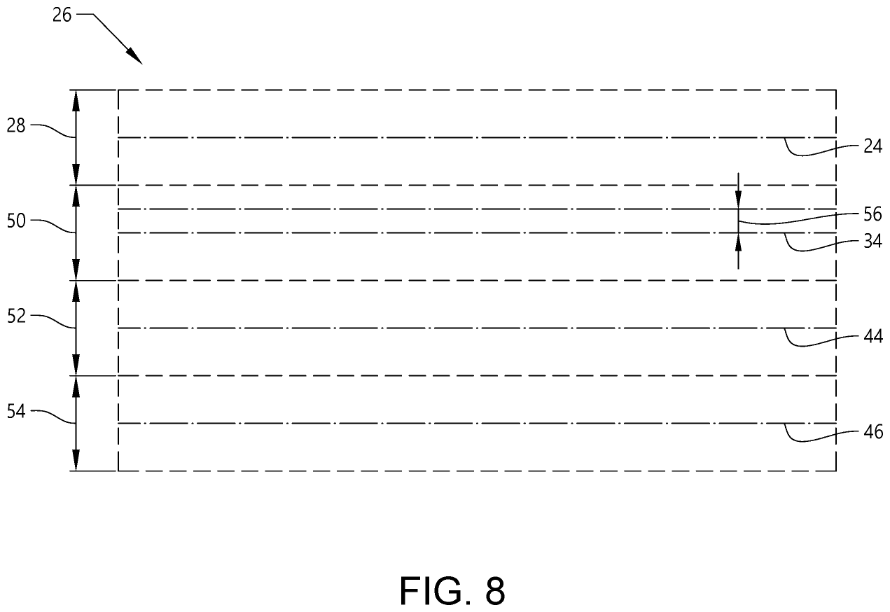

FIG. 8 illustrates a dump area 26 that has been generated using another embodiment of the management unit 36 or using another functionality of a management unit 36. In FIG. 8, the management unit 36 may be adapted to split the dump area 26 into a plurality of adjacent dump paths 24, 34, 44, 46, wherein each dump path is associated with a dump path width profile 28, 50, 52, 54 such that the plurality of dump paths 24, 34, 44, 46 covers the dump area 26. As a non-limiting example, the management unit 36 may be adapted to split the dump area 26 into a plurality of adjacent dump paths 24, 34, 44, 46 before any material has been filled into the dump area.

Moreover, as indicated in FIG. 8, the management unit 36 may be adapted to determine a transversal dump path deviation threshold 56 for a dump path 34. In the FIG. 8 example, the transversal dump path deviation threshold 56 is indicated for a second dump path 34 in a dump area 26.

The transversal dump path deviation threshold 56 is indicative of how much an autonomous dump machine is allowed to transversally deviate from the dump path 34 in a direction towards an adjacent path. The adjacent path is in FIG. 8 exemplified as a first dump path 24. Moreover, the management unit 36 is adapted to determine the transversal dump path deviation threshold 56 on the basis of the dump map 48, such as the dump map 48 that has been discussed hereinabove with reference to FIG. 7.

Moreover, the management unit 36 may be adapted to set a first transversal dump path deviation threshold for a dump path based on a determination that the adjacent dump path is at least partially filled with material. Moreover, the management unit 36 may be adapted to set a second transversal dump path deviation threshold for a dump path based on a determination that the adjacent dump path is not filled with material. The first transversal dump path deviation threshold is greater than the second transversal dump path deviation threshold.

Thus, using FIG. 7 and FIG. 8 as examples, when the first dump path 24 is filled with material, such a condition is indicated in FIG. 7, the management unit 36 sets a first transversal dump path deviation threshold for the second dump path 34 to thereby allow an autonomous dump machine 10, 38 to move in a transversal direction T from the second dump path 34 towards the first dump path 24 before dumping the loaded material.

However, in a condition in which the first dump path 24 is not filled with material, the management unit 36 sets a second transversal dump path deviation threshold for the second dump path 34, the second transversal dump path deviation threshold is smaller than the first transversal dump path deviation threshold which may thus prevent an autonomous dump machine 10, 38 from moving too much in the transversal direction T towards the first dump path 24.

It should be noted that the above presentation of the management unit 36 and the system 33 comprising the management unit 36 and a plurality of autonomous dump machines 10, 38 should also be regarded as disclosing a method for dumping material in a dump area using a system 33 comprising a management unit 36 and a plurality of autonomous dump machines 10, 38.

It is to be understood that the present invention is not limited to the embodiments described above and illustrated in the drawings; rather, the skilled person will recognize that many changes and modifications may be made within the scope of the appended claims.

1. A management unit for managing material dumping in a dump area using a plurality of autonomous dump machines, each autonomous dump machine comprising a sensor arrangement adapted to determine at least one sensor arrangement parameter indicative of the environment adjacent to at least a portion of said autonomous dump machine, said management unit being adapted to:
a. establish a set of dump paths, comprising at least one dump path, wherein each dump path extends in said dump area, and
b. issue an instruction to an autonomous dump machine of said plurality of autonomous dump machines to follow a dump path of said set of dump paths until said sensor arrangement parameter, determined by said sensor arrangement, indicates that said autonomous dump machine has reached a dumping position indicative of a dumping density of said dump area being within a predetermined dumping density range.

2. The management unit according to claim 1, wherein said management unit is adapted to receive dump information from said autonomous dump machine relating to where said autonomous dump machine has dumped its load, preferably said management unit is also adapted to receive shape information indicative of the shape of the load dumped by said autonomous dump machine, said management unit further being adapted to generate a dump map indicative of material currently dumped in said dump area on the basis of the received information.

3. The management unit according to claim 2, wherein said management unit is adapted to determine a set of dump paths comprising at least one dump path on the basis of at least said dump map.

4. The management unit according to claim 2, wherein said management unit is adapted to determine a transversal dump path deviation threshold for a dump path, said transversal dump path deviation threshold being indicative of how much an autonomous dump machine is allowed to transversally deviate from said dump path in a direction towards an adjacent dump path, said management unit being adapted to determine said transversal dump path deviation threshold on the basis of said dump map.

5. The management unit according to claim 4, wherein said management unit is adapted to set a first transversal dump path deviation threshold for a dump path based on a determination that said adjacent dump path is at least partially filled with material, said management unit being adapted to set a second transversal dump path deviation threshold for a dump path based on a determination that said adjacent dump path is not filled with material, said first transversal dump path deviation threshold being greater than said second transversal dump path deviation threshold.

6. The management unit according to claim 1, wherein said management unit is adapted to split said dump area into a plurality of adjacent dump paths, each dump path being associated with a dump path width profile such that the plurality of dump paths covers said dump area.

7. A system for material dumping in a dump area, said system comprising the management unit according to claim 1 and a plurality of autonomous dump machines, each autonomous dump machine comprising a sensor arrangement adapted to determine at least one sensor arrangement parameter indicative of the environment adjacent to at least a portion of said autonomous dump machine.

8. The system according to claim 7, wherein said sensor arrangement parameter is indicative of a dump material height of dump material located in front of said autonomous dump machine, as seen along said dump path, said autonomous dump machine being adapted to determine that said autonomous dump machine has reached said dumping position in response to determining that said dump material height equals or exceeds a predetermined dump material height threshold value.

9. The system according to claim 7, wherein said dump path is associated with a dump path width profile, said autonomous dump machine being adapted to use sensor information from said sensor arrangement being related to, preferably limited to, information within said dump path width profile.

10. The system according to claim 7, wherein said sensor arrangement is adapted to determine an inclination of said autonomous dump machine.

11. The system according to claim 10, wherein said sensor arrangement is adapted to detect a pitch of said autonomous dump machine, said autonomous dump machine being adapted to determine that said autonomous dump machine has reached said dumping position in response to determining that said detected pitch equals or exceeds a predetermined pitch inclination threshold angle.

12. The system according to claim 10, wherein said sensor arrangement is adapted to detect a roll of said autonomous dump machine, said autonomous dump machine being adapted to determine that said autonomous dump machine should discontinue following said dump path in response to determining that said detected roll equals or exceeds a predetermined roll inclination threshold angle.

13. The system according to claim 7, wherein each autonomous dump machine of said plurality of autonomous dump machines is adapted to dump material carried by said autonomous dump machine at said dumping position.

14. An autonomous dump machine comprising a sensor arrangement adapted to determine at least one sensor arrangement parameter indicative of the environment adjacent to at least a portion of said autonomous dump machine, said autonomous dump machine being adapted to receive information relating to a dump path forming part of a dump area intended to be filled with dump material, said autonomous dump machine being adapted to follow said dump path until said sensor arrangement parameter, determined by said sensor arrangement, indicates that said autonomous dump machine has reached a dumping position indicative of a dumping density of said dump area being within a predetermined dumping density range, said autonomous dump machine further being adapted to dump material carried by said autonomous dump machine at said dumping position.

15. The autonomous dump machine according to claim 14, wherein said sensor arrangement parameter is indicative of a dump material height of dump material located in front of said autonomous dump machine, said autonomous dump machine being adapted to determine that said autonomous dump machine has reached said dumping position in response to determining that said dump material height equals or exceeds a predetermined dump material height threshold value.

16. The autonomous dump machine according to claim 15, wherein said autonomous dump machine is adapted to receive information relating to a dump path width profile associated with said dump path, said autonomous dump machine being adapted to use sensor information from said sensor arrangement being related to, preferably limited to, information within said dump path width profile.

17. The autonomous dump machine according to claim 14, wherein said sensor arrangement is adapted to determine an inclination of said autonomous dump machine.

18. The autonomous dump machine according to claim 17, wherein said sensor arrangement is adapted to detect a pitch of said autonomous dump machine, said autonomous dump machine being adapted to determine that said autonomous dump machine has reached said dumping position in response to determining that said detected pitch equals or exceeds a predetermined pitch inclination threshold angle.

19. The autonomous dump machine according to claim 17, wherein said sensor arrangement is adapted to detect a roll of said autonomous dump machine, said autonomous dump machine being adapted to determine that said autonomous dump machine should discontinue following said dump path in response to determining that said detected roll equals or exceeds a predetermined roll inclination threshold angle.

20. The autonomous dump machine according to claim 14, wherein said sensor arrangement comprises a LIDAR sensor and/or a RADAR sensor.

21. The autonomous dump machine according to claim 14, wherein said autonomous dump machine is adapted to detect, preferably using said sensor arrangement, whether or not a portion of said dump area located adjacent to said dump path, as seen in a transversal direction perpendicular to a path extension along said dump path, is filled with material.

22. The autonomous dump machine according to claim 21, wherein said autonomous dump machine is adapted to, in response to detecting that said portion of said dump area located adjacent to said dump path is filled with material, use said sensor arrangement for determining a dumping position in said transversal direction indicative of a dumping density of said dump area being within a predetermined dumping density range.

23. A method for dumping material in a dump area using a system comprising a management unit and a plurality of autonomous dump machines, each autonomous dump machine comprising a sensor arrangement adapted to determine at least one sensor arrangement parameter indicative of the environment adjacent to at least a portion of said autonomous dump machine, said method comprising using said management unit for:
a. establishing a set of dump paths, comprising at least one dump path, wherein each dump path extends in said dump area, and
b. issuing an instruction to an autonomous dump machine of said plurality of autonomous dump machines to follow one of said dump paths until said sensor arrangement parameter, determined by said sensor arrangement, indicates that said autonomous dump machine has reached a dumping position indicative of a dumping density of said dump area being within a predetermined dumping density range, whereby said autonomous dump machine thereafter dumps material carried by said autonomous dump machine at said dumping position.

24. The method according to claim 23, further comprising receiving, by said management unit, dump information from said autonomous dump machine relating to where said autonomous dump machine has dumped its load, preferably said method further comprises receiving from said autonomous dump machine shape information indicative of the shape of the load dumped by said autonomous dump machine, said method further comprising generating a dump map, using said management unit, indicative of material currently dumped in said dump area on the basis of the received information.

25. The method according to claim 24, further comprising determining a set of dump paths comprising at least one dump path on the basis of at least said dump map.

26. The method according to claim 24, further comprising determining a transversal dump path deviation threshold for a dump path, said transversal dump path deviation threshold being indicative of how much an autonomous dump machine is allowed to transversally deviate from said dump path in a direction towards an adjacent dump path, said method comprising determining said transversal dump path deviation threshold on the basis of said dump map.

27. The method according to claim 26, comprising setting a first transversal dump path deviation threshold for a dump path based on a determination that an adjacent dump path is at least partially filled with material, and setting a second transversal dump path deviation threshold for a dump path based on a determination that an adjacent dump path (is not filled with material, said first transversal dump path deviation threshold being greater than said second transversal dump path deviation threshold.

28. The method according to claim 23, comprising splitting said dump area into a plurality of adjacent dump paths, each dump path being associated with a path width profile such that the plurality of dump paths covers said dump area.

29. The method according to claim 23, wherein said sensor arrangement parameter is indicative of a dump material height of dump material located in front of said autonomous dump machine, said method comprising determining that said autonomous dump machine has reached said dumping position in response to determining that said dump material height equals or exceeds a predetermined dump material height threshold value.

30. The method according to claim 23, wherein said dump path is associated with a dump path width profile, said method comprising using sensor information related to, preferably limited to, information within said dump path width profile.
